(19) United States
(12) Patent Application Publication
(10) Pub. No.: US 2006/0040068 A1
(43) Pub. Date: Feb. 23, 2006

(54) Method of manufacturing a cholesteric layer

(75) Inventors: Rene Theodorus Wegh, Eindhoven (NL); Johan Lub, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.J., BA Eindhoven (NL)

(21) Appl. No.: 10/533,059

(22) PCT Filed: Oct. 7, 2003
(86) PCT No.: PCT/IB03/04430

§ 371 Date: Apr. 27, 2005

(30) Foreign Application Priority Data
Nov. 1, 2002 (NL) 1021807

(51) Int. Cl. C09K 19/00

(52) U.S. Cl. 428/1.2

(57) ABSTRACT

The invention pertains to a method of manufacturing a layer of a cholesterically ordered polymer material, in which the material is oriented in such a way that the axis of the molecular helix of the cholesterically ordered material extends transversely to the layer, wherein the method comprises the steps: a) providing a layer comprising a cholesterically ordered mixture of a low-molecular weight polymerizable material and a high-molecular weight material, which high-molecular weight material comprises a quantity of a convertible group, which in its non-converted and in its converted state determines the pitch or the material to a different extent, the conversion of said high-molecular weight material being inducible by radiation, and the layer absorbs said radiation; b) irradiating the layer to convert at least a part of the convertible groups it the irradiated parts of the layer; c) letting at least the low-molecular weight material reorient to form the required helical structure; d) at least partially polymerizing and/or cross-linking the low-molecular weight material with itself and/or with the high-molecular weight material to freeze in the formed structure.

The invention pertains to a method of manufacturing a layer of a cholesterically ordered polymer material, in which the material is oriented in such a way that the axis of the molecular helix of the cholesterically ordered material extends transversely through the layer. The invention more particularly relates to a method of manufacturing cholesteric color filters having a patterned layer of a cholesterically ordered material.

Cholesteric color filters (CCF) can be used for reflective and transmissive liquid crystal displays. The process of making these filters consists of applying a solution of a mixture of nematic diacrylates, a photosensitive chiral compound and a photo-initiator on a substrate by a coating technique (e.g. spin-coating). Color formation is done by irradiation through a mask. The colors are fixed by photo-polymerization under nitrogen upon which the color filter is obtained as a stable cross-linked film. The reflection bandwidth of the CCF is limited to about 50 nm in the blue and about 70 nm in the red. This is determined by the birefringence Δn of the materials, which is about 0.15 for the mixtures currently used. This implies that three reflection bands centered in the blue, green, and red together do not cover the complete visible spectrum (400-700 nm). In comparison, the transmission bands of absorbing color filters are about 100 nm wide. Consequently, a reflective LCD with cholesteric color filters is less bright than a reflective LCD with absorbing color filters. Therefore it is highly desired to broaden the reflection bands of the CCF. Also for application in transmissive LCD broadening is important. In this case the CCF reflects two primary colors and transmits the third. Although a backlight generally emits narrow spectral bands, there will always be an angular distribution of emitted light. The reflection band of a cholesteric layer shifts to shorter wavelength under oblique angle. Consequently, to reflect the red, green and blue light under all emission angles, the CCF needs to exhibit broad reflection bands. Thus, for application in reflective as well as transmissive LCD broadening of the reflection bands of the CCF is important.

A solution is the combination of photo-structuring to get red, green, and blue pixels with broadening of the reflection bands by introducing a variation in pitch transverse to the layer. One way to obtain such a pitch variation is by applying a gradient in rate of photo-polymerization by an UV absorption gradient. Methods of this type are known per se.

For example, a gradient in the pitch transverse to the layer could be obtained by a method described in the U.S. Pat. No. 5,793,456, which discloses a method of manufacturing a cholesteric polarizer by providing a mixture of chiral and nematogenic monomers, each having a different reactivity, in the form of a layer. The pitch of the molecular helix is governed by the ratio between the chiral and the mesogenic monomer in the polymer material. Owing to the difference in reactivity between both monomers, the capture probability of the most reactive monomer is greater than that of the least reactive monomer. If during the polymerization of the mixture, which is initiated by actinic radiation, a variation in the radiation intensity is realized across the optically active layer to be formed, the most reactive monomer is preferably incorporated in the polymer at the locations of the highest radiation intensity. As a result, one or more concentration gradients of free monomer are formed during said polymerization process, causing monomer diffusion from locations with a high monomer concentration to locations with a low monomer concentration. This leads to an increase in reactive monomers in areas of the formed polymer material where, during the polymerization process, the radiation intensity was highest. As a result, the composition of the polymer material varies in the direction transverse to the polymer layer, causing a variation in the pitch of the molecular helix in the layer, which molecular helix is formed by the polymer. This variation of the pitch provides the optically active layer with a large bandwidth, the value of which is proportional to the value of the variation in pitch.

The known method of U.S. Pat. No. 5,793,456 has drawbacks. For example, it cannot or can hardly be combined with a lateral pitch variation. In addition, the speed of the process is governed by the diffusion of the monomer molecules, which is an inherently slow process. The present invention provides a rapid method in which a pitch of the molecular helix can be made to vary transversely to the layer in combination with a lateral pitch variation.

In WO 00/34808 a method was disclosed to obtain transversely a pitch difference by a method of manufacturing a layer of a cholesterically ordered polymer material, in which the material is oriented in such a way that the axis of the molecular helix of the cholesterically ordered material extends transversely to the layer, wherein the method comprises the following steps: providing a layer comprising a cholesterically ordered material, which material comprises a quantity of a convertible compound which in its non-converted and in its converted state determines the pitch of the cholesterically ordered material to a different extent, the conversion of said compound being inducible by radiation, and the layer substantially absorbs said radiation; irradiating the layer so that at least a part of the convertible compound in the irradiated parts of the layer is converted; and polymerizing and/or cross-linking the cholesterically ordered material to form a three-dimensional polymer. This method can in principle be used to create a transverse pitch variation combined with a lateral pitch variation. However, a serious disadvantage is the fact that when low-molecular weight materials are used, preserving the formed pitch gradient is impossible. The use of low-molecular weight materials is needed to obtain a low viscosity of the mixture, which is necessary for a fast color change after conversion of the convertible compound in the irradiated parts. Because of the high mobility of the molecules, the concentration gradient of converted and unconverted compounds, which induces the pitch gradient, is cancelled out by diffusion in a matter of seconds at room temperature. In other words, the method described does not result in the transversal pitch variation desired.

It is an object of the invention to obviate the known drawbacks. More particularly, it is an object of the invention to provide a method in which the layer can be patterned at the same temperature and in which relatively large pitch differences through the layer can be realized with any cholesterically ordered polymer in a simple manner. It is a further object of the invention to provide a cholesteric color filter having a patterned layer of a cholesterically ordered material, manufactured by means of this method.

These and other objects of the invention are achieved by means of a method comprising the steps:
a. providing a layer comprising a cholesterically ordered mixture of a low-molecular weight polymerizable material and a high-molecular weight material, which high-molecular weight material comprises a quantity of a convertible group, which in its non-converted and in its converted state determines the pitch of the material to a different extent, the conversion of said high-molecular weight material being inducible by radiation, and the layer absorbs said radiation;
b. irradiating the layer to convert at least a part of the convertible groups in the irradiated parts of the layer;
c. letting at least the low-molecular weight material reorient to form the required helical structure;
d. at least partially polymerizing and/or cross-linking the low-molecular weight material with itself and/or with the high-molecular weight material to freeze in the formed structure.

It has been found that by using the method according to the invention, patterned layers of cholesterically ordered, liquid crystalline material can be manufactured in a simple way at the same temperature, with the maximum pitch difference in the layer being relatively large.

Preferably, the layer comprises laterally sections with different main reflection wavelengths. In this manner suitable CCF's can be made. The process to make a CCF according to the present invention is very simple. Preferably, the conversion of said high-molecular weight material is due to an isomerization step under the influence of irradiation, i.e. photo-isomerization. After photo-isomerization and before photo-polymerization the molecules have to re-orient to form the optimum helical structure, without diffusing thereafter and thereby destroying the pitch gradient. The high-molecular weight material, which determines the value of the pitch by the extent of conversion of the convertible groups, diffuses extremely slowly because of its high-molecular weight, whereas the low-molecular weight, and therefore mobile, material is able to diffuse to give the optimum pitch by re-orientation. By (partial or complete) polymerization and/or cross-linking, the pitch of the molecular helix in the layer is fixed. In this way, a patterned layer of cholesterically ordered material can be manufactured in a simple manner. In a preferred embodiment, the CCF layer is made by subsequent coating, photo-conversion, and photo-polymerization. Preferably, the mixture is selected as to give a reflection in the blue region before irradiation. More preferably the photo-conversion is a photo-isomerization. More preferably the mixture of high-molecular weight and low-molecular weight materials further comprises a dye absorbing at a wavelength at which the photo-isomerizable group isomerizes.

In another preferred embodiment according to the invention the method comprises that steps b and c are repeated before performing step d. Such repetition can be done once or several times.

In an embodiment according to the invention irradiation is performed through a photo-mask at a wavelength at which the photo-convertible group is converted, and for which there is an absorption gradient. Thus this wavelength is selected at the wavelength at which one of the compounds absorbs strongly, or at the wavelength at which a UV absorber, added for this purpose, absorbs. This is a very simple method, only suffering from the fact that no broadening occurs in the blue region. However, a very strong broadening is obtained for the red region resulting in extension of the reflection band into the infrared (IR) spectral region. This can improve the viewing angle particularly for application in reflective LCD, because the reflection in the IR shifts to the red under oblique angle, thereby compensating the shift to green of the red reflecting part.

When broadening of the three reflection bands is necessary, such as for application in transmissive LCD, the photo-conversion can be performed in two steps. The first irradiation step is through a photo-mask with light at a wavelength for which there is no absorption gradient. The reflection bands are then positioned at wavelengths slightly shorter than the optimum wavelengths for blue, green, and red. The second irradiation step is a flood exposure irradiation at a wavelength for which there is an absorption gradient, so that at the side of the layer closest situated to the irradiation source (lamp) the pitch of the layer is changed (slightly enlarged) for all three colors, whereas the pitch is not or only slightly changed at the other side of the layer. In this manner reflection bands with a width of at least 100 nm for each of the colors are obtained. It is useful to apply a UV absorber, for instance an olefinic compound, with a steep absorption increase at about 340 nm and carry out the irradiation steps at for instance 350 and 315 nm, respectively. When the cholesteric mixture itself has a steep absorption increase at about 340 nm, this method can be applied without the need for a UV absorber. It is also possible to reverse the first and second irradiation steps.

In a further embodiment, the two above irradiation steps can also be performed at the same wavelength. According to this embodiment a first irradiation step is carried out through a photo-mask at a wavelength for which there is an absorption gradient. A very large pitch difference for the green and red regions is thus obtained, resulting in reflection bands spanning the complete visible range. The high-molecular weight material cannot diffuse at room temperature, however at elevated temperature the high-molecular weight material can diffuse to cancel out the transverse pitch difference. Thus after an annealing step (for instance, heating at about 70° C. for several minutes) the gradients are completely cancelled out, leading to reflection bands at wavelengths slightly shorter than the optimum wavelengths for blue, green, and red. A second flood-exposure irradiation broadens these bands equally. This method has the advantage over the previous method that only one lamp is required and that substantially more types of TV absorbers can be used.

A suitable mixture comprises a nematic acrylate- or methacrylate-functional monomer, preferably acrylate- or methacrylate-functional monomers having at least two acrylate or methacrylate groups. The mixture most preferably used to make CCF's mainly consists of diacrylates, leading to a very high cross-link density and thus a good thermal stability. Other polymerizable groups than acrylate groups can equally well be used. Thus the low-molecular weight material is preferably a monomer or a mixture of monomers that is soluble in the solvent used for dissolving the high-molecular weight material. The mixture can then be coated by e.g. spin-coating on the CCF.

The high-molecular weight material is preferably an oligomer or a polymer or a mixture of oligo- and/or polymers. Those oligomers and/or polymers comprise a photo-convertible group, preferably a photo-isomerizable group, and have a molecular weight in the range 500 to 20000, preferably 3000 to 8000, more preferably 4000 to 6000. The high-molecular weight material possibly (but not necessarily) contains polymerizable groups to further increase the cross-link density.

The conversion of the convertible groups of the high-molecular weight material is effected by irradiation with energy in the form of, for example, electromagnetic radiation, nuclear radiation or an electron beam. Preferably said conversion is effected by means of UV radiation.

In accordance with a preferred embodiment of the invention, the inventive color filter is characterized in that the pitch of the molecular helix increases substantially continuously from a minimum value at one surface of the layer to a maximum value at the other surface of the layer. By means of this particular configuration it is attained that the helical structure of the cholesteric material, viewed in the direction of the normal to the layer, changes gradually. This precludes the occurrence of material stresses in the optical layer and has a favorable effect on the strength of said layer.

Another favorable embodiment of the filter according to the invention is characterized in that the polymer material forms a three-dimensional network. Optically active layers, which consist of such three-dimensional networks are exceptionally mechanically and thermally stable.

The invention is illustrated by the following non-limitative examples.

### EXAMPLE 1

On a clean glass surface polyimide was applied by spin-coating followed by baking and rubbing. 1.0 g of a mixture of 30.9% of high-molecular weight material I, 50.2% of diacrylate II, 12.7% of diacrylate III, 1.1% of 2-(N-ethylperfluorooctanesulfonamido)-ethylacrylate (ex Acros), 4.1% of Tinuvin® 1130 (ex Ciba) (UV absorber), and 1.0% of Darocur® 4265 (ex Ciba) (photo-initiator) were mixed with 1.0 g of xylene containing 100 ppm of 4-methoxyphenol (inhibitor).

The homogeneous solution was filtered and spin-coated for 30 sec at 1000 rpm (Convac) on the polyimide surface. After a heating step at 70° C. for 1 min the film was irradiated by UV light from a Philips HPA lamp (4 mW/cm² at 365 nm) in air for 30 seconds. In a second irradiation step with the same lamp in air the film was irradiated for 0, 1, and 2 minutes to obtain a blue, green, and red region, respectively. Subsequently, the film was annealed at 70° C. for 2 minutes and photo-polymerized under nitrogen by irradiation with the same lamp for 8 minutes. The polymerization was finalized by post-curing for 90 minutes at 150° C. in nitrogen. The transmission spectra for the three regions of this sample show a very strong broadening of the reflection band of the red region, a strong broadening of the green band, and a slight broadening of the blue reflection band due to the flood exposure irradiation step of 30 sec. The reflection bandwidth of the sample as prepared via the above method approaches the reflection bandwidth most desired for application in reflective LCD.

### EXAMPLE 2

On a clean glass surface polyimide was applied by spin-coating followed by baling and rubbing. 2.0 g of a mixture of 30.0% of high-molecular weight material IV, 54.3% of diacrylate II, 13.6% of diacrylate III, 1.1% of 2-(N-ethylperfluorooctanesulfonamido)-ethylacrylate (ex Acros), and 1.0% of Darocur® 4265 (ex Ciba) (photo-initiator) were mixed with 1.7 g of xylene containing 100 ppm of 4-methoxy-phenol (inhibitor).

The homogeneous solution was filtered and spin-coated for 30 sec at 2000 rpm (BLE) on the polyimide surface. After a heating step at 70° C. for 1 min the film was irradiated by UV light from a Philips HPA lamp, equipped with a filter transmitting wavelengths higher than 345 nm, in air for 0, 78, and 198 seconds for the blue, green, and red region, respectively. In a second irradiation step with the same lamp, but in this case equipped with a 315 nm bandpass filter, the whole film was irradiated in air for 40 seconds. Subsequently, the film was annealed at 70° C. for 30 sec and photo-polymerized under nitrogen by irradiation with the same lamp for 10 minutes. The polymerization was finalized by post-curing for 90 minutes at 150° C. in nitrogen. The transmission spectra show a broadening of the reflection bands to about 100 nm for all three regions of the sample. The reflection bandwidth of the sample as prepared via the above method approaches the reflection bandwidth most desired for application in transmissive LCD.

### EXAMPLE 3

On a clean glass surface polyimide was applied by spin-coating followed by baking and rubbing. 2.0 g of a mixture of 30.0% of high-molecular weight material IV, 51.2% of diacrylate II, 12.8% of diacrylate III, 1.0% of 2-(N-ethylperfluorooctanesulfonamido)ethylacrylate (ex Acros), 4.0% of Tinuvin® 1130 (ex Ciba) (UV absorber), and 1.0% of Darocur® 4265 (ex Ciba) (photo-initiator) were mixed with 1.6 g of xylene containing 100 ppm of 4-methoxyphenol (inhibitor).

The homogeneous solution was filtered and spin-coated for 30 sec at 1200 rpm (BLE) on the polyimide surface. After a heating step at 70° C. for 1 min, two thirds of the film were irradiated by UV light from a Philips HPA lamp (4 mW/cm² at 365 nm) in air for 42 seconds. One third of the film was not irradiated. Subsequently, the film was annealed at 70° C. for 5 minutes, resulting in a green reflection for two thirds and a blue reflection for one third of the film. In a second irradiation step with the same lamp in air the whole film was irradiated for 15 seconds. Subsequently, the film was annealed at 70° C. for 2.5 minutes and photo-polymerized under nitrogen by irradiation with the same lamp for 10 minutes. After an oxygen plasma treatment to improve the wetting, the UV curable topcoat 604 (ex Eques Coatings) was spin-coated for 30 sec at 3500 rpm (BLE) on top of the cholesteric layer. Subsequently, it was photo-polymerized under nitrogen for 10 minutes. The polymerization was finalized by post-curing for 90 minutes at 150° C. in nitrogen.

The complete procedure of applying polyimide, the cholesteric layer, and the topcoat was repeated, the only difference being the first irradiation step of the cholesteric layer. In this case two thirds of the film were irradiated in air for 162 sec to obtain a red reflection, and the remaining part was not irradiated to retain the blue reflection. The part of the film to irradiate was chosen such that the non-irradiated parts of the two cholesteric layers did not overlap. In this way three different regions were created, reflecting green and blue, green and red, and blue and red, respectively. The broadening of the reflection bands for this sample is similar to that of Example 2.

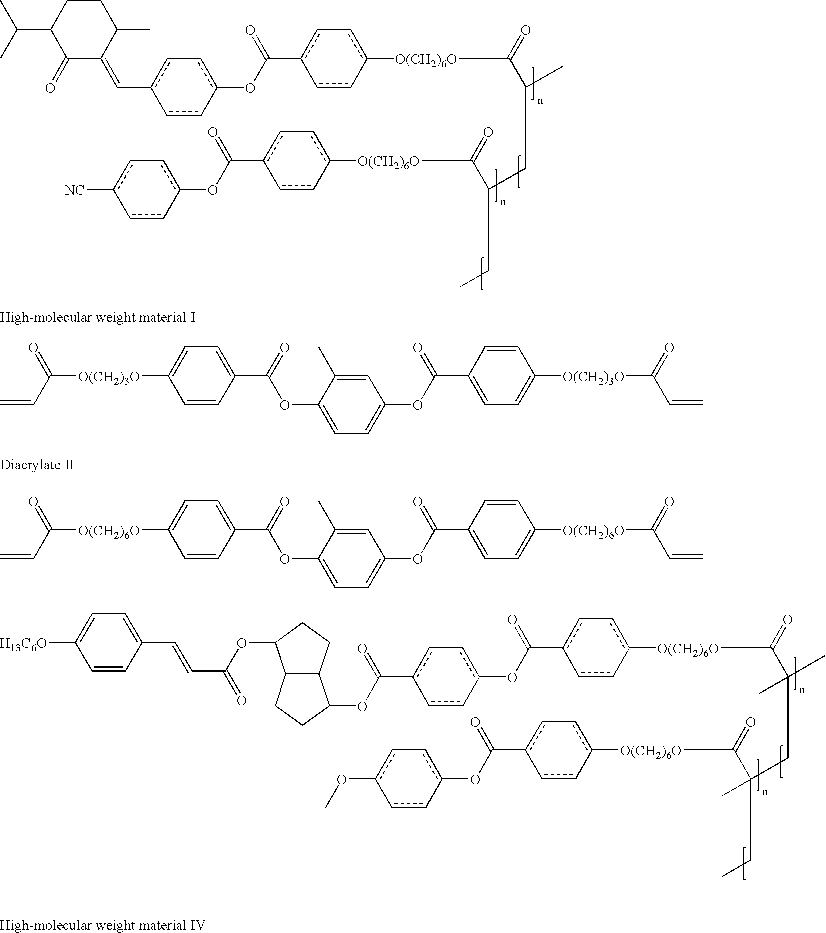

1. A method of manufacturing a layer of a cholesterically ordered polymer material, in which the material is oriented in such a way that the axis of the molecular helix of the cholesterically ordered material extends transversely to the layer, wherein the method comprises the steps:
a. providing a layer comprising a cholesterically ordered mixture of a low-molecular weight polymerizable material and a high-molecular weight material, which high-molecular weight material comprises a quantity of a convertible group, which in its non-converted and in its converted state determines the pitch of the material to a different extent, the conversion of said high-molecular weight material being inducible by radiation, and the layer absorbs said radiation;
b. irradiating the layer to convert at least a part of the convertible groups in the irradiated parts of the layer;
c. letting at least the low-molecular weight material reorient to form the required helical structure;
d. at least partially polymerizing and/or cross-linking the low-molecular weight material with itself and/or with the high-molecular weight material to freeze in the formed structure.

2. The method according to claim 1 wherein steps b and c are repeated before performing step d.

3. The method according to claim 1 wherein the low-molecular weight material comprises a nematic acrylate- or methacrylate-functional monomer.

4. The method according to claim 3 wherein at least part of the acrylate- or methacrylate-functional monomer comprises at least two acrylate or methacrylate groups.

5. The method according to claim 1 wherein the layer further comprises a dye absorbing at a wavelength at which the convertible group photo-isomerizes.

6. The method according to claim 1 wherein the layer comprises laterally sections with different main reflection wavelengths.

7. The method according to claim 1 wherein the layer is a cholesteric color filter.
